(19) United States
(12) Patent Application Publication
(10) Pub. No.: US 2024/0073121 A1
(43) Pub. Date: Feb. 29, 2024

(54) PATH DETERMINATION APPARATUS AND METHOD OF MOBILE COMMUNICATION SYSTEM

(71) Applicant: ELECTRONICS AND TELECOMMUNICATIONS RESEARCH INSTITUTE, Daejeon (KR)

(72) Inventors: Jong Seok LEE, Daejeon (KR); Sunjin KIM, Daejeon (KR); Namseok KO, Daejeon (KR); No Ik PARK, Daejeon (KR)

(21) Appl. No.: 18/234,933

(22) Filed: Aug. 17, 2023

(30) Foreign Application Priority Data
Aug. 23, 2022 (KR) 10-2022-0105613
Aug. 31, 2022 (KR) 10-2022-0109864

(51) Int. Cl. H04L 45/12; H04L 45/00

(52) U.S. Cl. CPC H04L 45/12; H04L 45/34

(57) ABSTRACT

Provided is a network function for determining a path for transmitting user data through the following steps: receiving, from an SMF, a path calculation request for a path for transmitting user data; and determining the path on the basis of information on a core network and information on a transport network coupled to a user plane layer of the core network.

### CROSS REFERENCE TO RELATED APPLICATIONS

The present application claims priority to Korean Patent Application No. 10-2022-0105613, filed 23 Aug. 2022, and Korean Patent Application No. 10-2022-0109864, filed 31 Aug. 2022, the entire contents of which are incorporated herein for all purposes by this reference.

### BACKGROUND OF THE INVENTION

### 1. Field of the Invention

The present disclosure relates to a path determination apparatus and method of a mobile communication system.

### 2. Description of Related Art

With the development of 5G mobile technology, various network-based application services have become widespread. Such application services have developed in a distributed micro service architecture based on network function virtualization (NFV). However, the current architecture of a mobile network was designed without considering the transport layer, making it difficult to quickly respond to the bandwidth and low latency requirements of various application services.

A user plane layer of a mobile communication system is divided into a wireless access section, a core network, and a service network connected through GTP-U-based tunneling, so it is difficult to optimize and operate network paths according to the requirements of individual application services.

The foregoing is intended merely to aid in the understanding of the background of the present disclosure, and is not intended to mean that the present disclosure falls within the purview of the related art that is already known to those skilled in the art.

### SUMMARY OF THE INVENTION

One embodiment provides a network function apparatus for determining a transmission path of user data.

Another embodiment provides a method of determining a transmission path of a core network and a transport network.

According to an embodiment, there is provided a network function in a core network. The network function includes a processor and a memory, wherein the processor is configured to execute at least one program stored in the memory to perform: receiving, from a session management function (SMF), a path calculation request for a path for transmitting user data; and determining the path on the basis of information on the core network and information on a transport network coupled to a user plane layer of the core network.

In the network function, the processor may be configured to execute the program to further perform receiving the information on the transport network from an external application function (AF) outside the core network, wherein the information on the transport network may include topology of the transport network and state information of network equipment in the transport network.

In the network function, the network equipment in the transport network may support a predetermined transmission protocol.

In the network function, the predetermined transmission protocol may be segment routing IPv6 (SRv6).

In the network function, the processor may be configured to execute the program to further perform: receiving the information on the core network from the SMF; and creating information on an integrated network on the basis of the information on the transport network and the information on the core network, wherein the information on the integrated network may include integrated topology of the core network and the transport network.

In the network function, when determining the path on the basis of the information on the core network and the information on the transport network coupled to the user plane layer of the core network, the processor may be configured to perform determining the path on the basis of state information of a network resource in the core network, the state information of the network equipment in the transport network, and topology of the integrated network.

In the network function, the path calculation request may include information on an ingress node and an egress node of the user data, and the ingress node and the egress node may be included in the user plane layer.

In the network function, the information on the ingress node and the egress node may include a segment routing IPv6 (SRv6) address of the ingress node and an SRv6 address of the egress node.

In the network function, the path calculation request may further include information on a service corresponding to the user data.

According to another embodiment, there is provided a network function in a core network. The network function includes a processor and a memory, wherein the processor is configured to execute at least one program stored in the memory to perform: receiving a session setting request for a session from a policy control function (PCF); determining an ingress node and an egress node of user data to be transmitted through the session; and transmitting a path setting request including information on the ingress node and the egress node to a routing support function (RSF).

According to still another embodiment, there is provided a path determination method of a core network and a transport network. The path determination method may include: receiving, from a session management function (SMF), a path calculation request for a path for transmitting user data; and determining the path on the basis of information on the core network and information on the transport network coupled to a user plane layer of the core network.

The path determination method may further include receiving the information on the transport network from an external application function (AF) outside the core network, wherein the information on the transport network may include topology of the transport network and state information of network equipment in the transport network.

In the path determination method, the network equipment in the transport network may support a predetermined transmission protocol.

In the path determination method, the predetermined transmission protocol may be segment routing IPv6 (SRv6).

The path determination method may further include: receiving the information on the core network from the SMF; and creating information on an integrated network on the basis of the information on the transport network and the information on the core network, wherein the information on the integrated network may include integrated topology of the core network and the transport network.

In the path determination method, the determining of the path on the basis of the information on the core network and the information on the transport network coupled to the user plane layer of the core network may include determining the path on the basis of state information of a network resource in the core network, the state information of the network equipment in the transport network, and topology of the integrated network.

In the path determination method, the path calculation request may include information on an ingress node and an egress node of the user data, and the ingress node and the egress node may be included in the user plane layer.

In the path determination method, the information on the ingress node and the egress node may include a segment routing IPv6 (SRv6) address of the ingress node and an SRv6 address of the egress node.

In the path determination method, the path calculation request may further include information on a service corresponding to the user data.

By determining an optimal transmission path of user data on the basis of information on the integrated network, various requirements of application services can be satisfied and the quality (bandwidth, latency, and reliability) of the application services can be improved.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a core network and a transport network according to an embodiment;

FIG. 2 is a block diagram illustrating a main function apparatus of a network according to an embodiment;

FIG. 3 is a flowchart illustrating a method of creating topology of an integrated network according to an embodiment;

FIG. 4 is a flowchart illustrating a session setting method according to an embodiment;

FIG. 5 is a flowchart illustrating a method of creating information on an integrated network according to an embodiment; and

FIG. 6 is a block diagram illustrating a network function in a core network according to an embodiment.

### DETAILED DESCRIPTION OF THE INVENTION

Hereinbelow, exemplary embodiments of the present disclosure will be described in detail with reference to the accompanying drawings such that the present disclosure can be easily embodied by those skilled in the art to which this present disclosure belongs. However, the present disclosure may be embodied in various different forms and should not be limited to the embodiments set forth herein. Further, in order to clearly explain the present disclosure, portions that are not related to the present disclosure are omitted in the drawings, and like reference numerals designate like elements throughout the specification.

Throughout the specification, a terminal may refer to a user equipment (UE), a mobile station (MS), a mobile terminal (MT), an advanced mobile station (AMS), a high-reliability mobile station (HR-MS), a subscriber station (SS), a portable subscriber station (PSS), an access terminal (AT), or a machine type communication device (MTC device), or may include all or some functions of the UE, MS, MT, AMS, HR-MS, SS, PSS, or AT.

In addition, a base station (BS) may refer to a node B, an evolved node B (eNB), a gNB, an advanced base station (ABS), a high-reliability base station (HR-BS), an access point (AP), a radio access station (RAS), a base transceiver station (BTS), a mobile multi-hop relay (MMR)-BS, a relay station (RS) acting as a base station, a relay node (RN) acting as a base station, an advanced relay station (ARS) acting as a base station, a high-reliability relay station (HR-RS) acting as a base station, or a small base station (a femto BS, a home node B (HNB), a home eNodeB (HeNB), a pico BS, a macro BS, a micro BS), etc.), or may include all or some functions of the NB, eNB, gNB, ABS, AP, RAS, BTS, MMR-BS, RS, RN, ARS, HR-RS, or small base station.

Throughout the specification, when a part “includes” an element, it is noted that it further includes other elements, but does not exclude other elements, unless specifically stated otherwise.

In the specification, each of the expressions “A or B”, “at least one of A and B”, “at least one of A or B”, “A, B, or C”, “at least one of A, B, and C”, and “at least one of A, B, or C” may include any one of the items listed together in that expression, or may include any possible combinations thereof.

In the specification, a term described in the singular may be interpreted as singular or plural unless an explicit term such as “one” or “single” is used.

In the specification, the term “and/or” includes each of the recited elements, and any combinations of one or more elements.

In the specification, the terms including ordinal numbers, such as “first”, “second”, etc., may be used to describe various elements, but the elements are not to be construed as being limited to the terms. The terms are only used to differentiate one element from other elements. For example, the “first” element may be named the “second” element without departing from the scope of the present disclosure, and the “second” element may also be similarly named the “first” element.

In the flowcharts described in the specification with reference to the drawings, the order of the steps may be changed, several steps may be merged, some steps may be divided, or particular steps may not be performed.

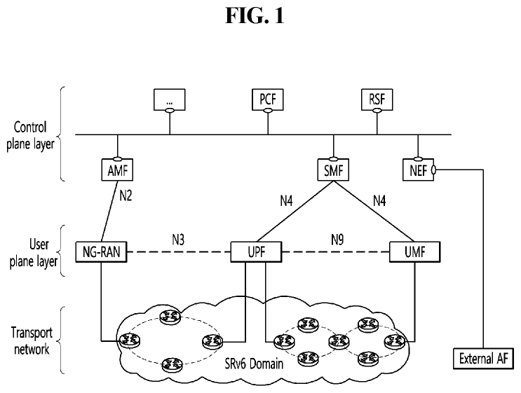

FIG. 1 is a diagram illustrating a core network and a transport network according to an embodiment.

Referring to FIG. 1, a core network according to an embodiment includes a user plane layer and a control plane layer.

The user plane layer may include an access network (an eNB, a gNB, or an NG-RAN) and a user plane function (UPF). By using a tunneling technology, user data may be transmitted between the access network and the UPF connected to a data network outside a mobile communication system. In an embodiment, a tunnel for user data may be created between an access network and UPFs (for example, a PDU session anchor (PSA) in a network) by using segment routing IPv6 (SRv6). That is, the network resources (an access network and an UPF) of the user plane layer of the core network may support SRv6 as a transmission protocol of user data SRv6 supports a source routing technology, so a path composed of UPFs appropriate for the characteristics of user data in the core network may be provided to an application service.

The control plane layer may include network functions (NFs) such as an access and mobility management function (AMF), a session management function (SMF), a network exposure function (NEF), a policy control function (PCF), and an application function (AF). The AMF of the control plane layer may be connected to an access network (an eNB, a gNB, or an NG-RAN) of the user plane layer through an N2 interface. The SMF of the control plane layer may be connected to an UPF of the user plane layer through an N4 interface.

The NFs in the control plane layer may require data paths that are capable of meeting the requirements of various application services. To this end, a routing support function (RSF) according to an embodiment may create an optimal data transmission path considering both information on the core network and information on the transport network.

The control plane layer according to an embodiment may further include an RSF to create a data path considering information on the transport network. The RSF according to an embodiment may collect information on the core network and the transport network to build integrated network topology, and may use an optimal path calculation algorithm to create an optimal data transmission path that is capable of meeting the requirements of an application service. The RSF may collect information on the core network from the SMF, and may collect information on the transport network through an external AF outside the mobile communication system.

The information on the core network may include topology between an access network and an UPF in the core network, and state information of network resources constituting the access network and the UPF. Herein, the network resources constituting the access network and the UPF may support a predetermined transmission protocol (for example, SRv6).

The transport network may include a plurality of routers, switches, and service servers connected to a cloud or a network, and network equipment, such as routers, switches, and servers of the transport network, may have an SRv6-aware function. The transport network is coupled to the user plane layer of the core network, and the network equipment included in the transport network may transmit user data between an access network and UPFs in the user plane layer.

By using SRv6, each piece of network equipment of the transport network may accommodate various application services and may realize traffic engineering through a programmable network technology. Herein, the information on the transport network collected by the RSF may include information on the network equipment supporting SRv6.

As described above, the RSF according to an embodiment may determine a path for user data transmission and QoS control considering both the core network of the mobile communication system and the transport network coupled to the core network.

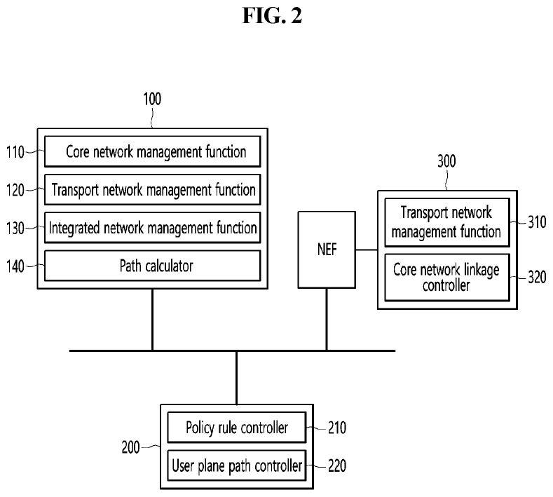

FIG. 2 is a block diagram illustrating a main function apparatus of a network according to an embodiment.

Referring to FIG. 2, an RSF 100 according to an embodiment may include a core network management function 110, a transport network management function 120, an integrated network management function 130, and a path calculator 140.

The RSF 100 according to an embodiment may receive topology and state information of a core network from an SMF 200 and may store the same in the core network management function 110. In an embodiment, the RSF 100 may collect the topology and state information of the core network from the SMF 200 periodically or non-periodically. For example, when the topology and/or state information of the core network is changed or the topology and/or state information of a transport network is updated, the SMF 200 may transmit the changed or updated topology and state information of the core network to the RSF 100. Alternatively, when requesting the RSF 100 to calculate an optimal path, the SMF 200 may transmit the topology and state information of the core network.

The RSF 100 according to an embodiment may receive topology and state information of the transport network from an external AF 300 connected to an NEF and may store the same in the transport network management function 120. In an embodiment, the RSF 100 may collect the topology and state information of the transport network from the external AF 300 periodically or non-periodically. For example, when the topology and/or state information of the transport network is changed or updated, the external AF 300 may transmit the changed or updated topology and state information of the transport network to the RSF 100. Alternatively, after the RSF 100 receives a request from the SMF 200 to calculate an optimal path, the RSF 100 may make a request to the external AF 300 for the topology and state information of the transport network via the NEF.

The RSF 100 according to an embodiment may add information (topology and state information of the transport network) on the transport network to information on the core network to create information on an integrated network, and may store the created information on the integrated network in the integrated network management function 130. The information on the integrated network may include integrated topology and state information of the core network and the transport network. The state information (state information of network equipment in the core network and the transport network) of the core network and the transport network may include link up/down, and link cost. The information on the integrated network may include performance data of the integrated network or performance data of the network equipment in the integrated network.

The RSF 100 according to an embodiment may use the path calculator 140 to calculate, on the basis of information on the integrated network, a transmission path of user data that is capable of satisfying a request of the SMF 200. That is, the RSF 100 according to an embodiment may calculate, on the basis of information on the integrated network that is a combination of the core network and the transport network, a transmission path of user data that is capable of satisfying the requirements of an application service. When information on the integrated network includes collected performance data of the integrated network or collected performance data of the network equipment in the integrated network, the RSF 100 may use the collected data of the integrated network and/or the performance data of the network equipment in calculating a transmission path of user data.

The SMF 200 according to an embodiment may include a policy rule controller 210 and a user plane path controller 220. When a session setting request is received from a PCF, the policy rule controller 210 may create a parameter value required for session setting and may transmit the created parameter value to the RSF 100, thereby requesting the RSF 100 to calculate an optimal path. Afterward, when a result of calculating an optimal path is received from the RSF 100, the SMF 200 may use the user plane path controller 220 to set a transmission path of user data on a user plane.

The external AF 300 is an application function, which manages information on the transport network, outside the communication system, and may include a transport network management function 310 and a core network linkage controller 320.

The transport network management function 310 may manage information (information on the transport network) on equipment that supports a predetermined transmission protocol among pieces of network equipment included in the transport network. In an embodiment, the predetermined transmission protocol may be SRv6, and information on equipment supporting SRv6 may include network topology composed of the equipment supporting SRv6, and state information of the equipment supporting SRv6. In addition, the information on the equipment supporting SRv6 may include an address of the network equipment, and link information of the network equipment.

The core network linkage controller 320 may transmit the information on the transport network stored in the transport network management function 130 to the RSF 100 of the core network via the NEF of the core network.

As described above, the RSF according to an embodiment collects topology and state information of the core network and the transport network from the SMF in the core network and the external AF outside the core network, respectively, thereby determining a path optimized throughout the core network and transport network.

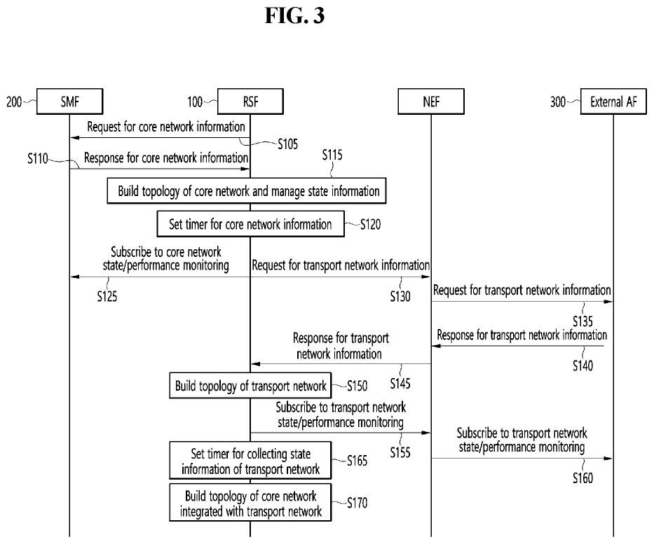

FIG. 3 is a flowchart illustrating a method of creating topology of an integrated network according to an embodiment.

Referring to FIG. 3, an RSF 100 according to an embodiment may make a request to an SMF 200 for information on a core network in step S105, and may receive the information on the core network from the SMF 200 in step S110. Afterward, the RSF 100 may create topology of the core network on the basis of the information on the core network, and may manage state information of network resources in the core network in step S115.

In an embodiment, after receiving the information on the core network from the SMF 200, the RSF 100 may start a timer for periodically collecting information on the core network in step S120. When the timer expires, the RSF 100 may make a request to the SMF 200 for information on the core network again, and may receive the information on the core network from the SMF 200.

In an embodiment, the RSF 100 may make a request to the SMF 200 for event subscription for monitoring the state/performance of the core network in step S125.

Referring to FIG. 3, the RSF 100 according to an embodiment may make a request to the NEF for information on a transport network in step S130, and an NEF may transmit, to an external AF 300 connected thereto, the request for the information on the transport network in step S135. After receiving the request for the information on the transport network, the external AF 300 may transmit the information on the transport network to the RSF 100 via the NEF in steps S140 and S145.

Afterward, the RSF 100 may create topology of the transport network on the basis of the information on the transport network, and may manage state information of each pieces of network equipment of the transport network in step S150. Herein, the information on the transport network may include topology and state information of network equipment supporting a predetermined transmission protocol (for example, SRv6).

In an embodiment, the RSF 100 may make a request to the NEF for event subscription for monitoring the state/performance of the transport network in step S155. Afterward, when receiving an event related to the state/performance of the transport network from the external AF 300, the NEF may notify the RSF 100 of this in step S160.

In an embodiment, after receiving the information on the transport network from the external AF 300, the RSF 100 may start a timer for periodically collecting information on the transport network in step S165. When the timer expires, the RSF 100 may make a request to the NEF for information on the transport network again, and may receive the information on the transport network from the external AF 300 via the NEF.

Referring to FIG. 3, the RSF 100 according to an embodiment may use the collected information on the core network and the collected information on the transport network to create topology of the integrated network, and may mange state information of network resources/equipment in the integrated network.

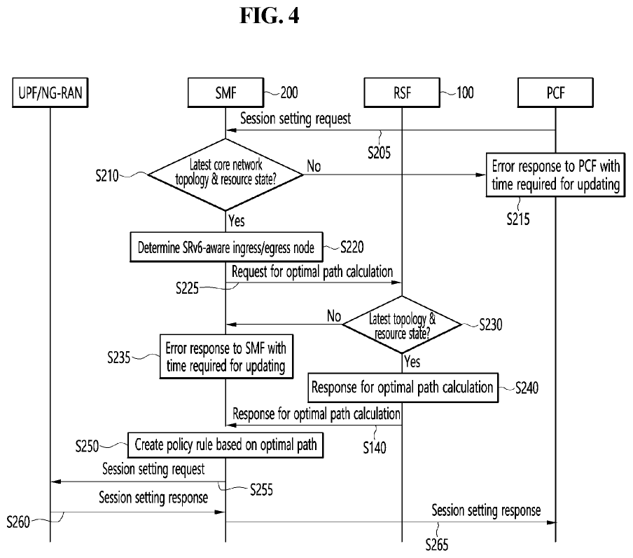

FIG. 4 is a flowchart illustrating a session setting method according to an embodiment.

Referring to FIG. 4, when a session setting request is received from a PCF in step S205, an SMF 200 may use information on a core network to determine an ingress node and an egress node for a session. The SMF 200 may determine an ingress node by using tracking area (TA) information within a policy and charging control rule (PCC rule) received from the PCF or by using ingress node information included in a session setting request message when the AMF requests session setting. In addition, the SMF 200 may determine an egress node of user data on the basis of a data network name (DNN) within the PCC rule. For data heading from a data network (DN) to a terminal, a path set in the direction of the data network from the terminal may be referenced. In an embodiment, an ingress node and an egress node may be an access network and/or an UPF (for example, SRv6-aware nodes) that is capable of supporting a predetermined transmission protocol.

In an embodiment, when the session setting request is received from the PCF, the SMF 200 may determine whether current information on the core network is the latest information in step S210. When the current information on the core network is not the latest information, the SMF 200 may transmit an error response to the PCF in step S215. When the SMF 200 transmits the error response to the PCF, the SMF 200 may transmit, to the PCF, information on the time required to update the user plane.

Herein, “updating” refers to the operation in which the SMF 200 collects state information of the core network. In an embodiment, when information on the core network is not the latest information, the SMF 200 needs to collect (update) state information of the core network from the network equipment managed by the SMF 200. The SMF 200 may transmit the error response and the information on the time required for updating together to the PCF. By receiving the information on the time required for updating from the SMF 200, the PCF may not transmit a session setting request to the SMF 200 again during the updating operation of the SMF 200. When the information (topology of the core network and/or state information of network resources in the core network) on the core network currently stored in the SMF 200 is the latest information, the SMF 200 may determine an ingress node and egress node for a session in step S220.

The SMF 200 may record the collection time point when the information on the core network is collected, and may compare the recorded collection time point with a freshness period of the information to determine whether the information on the core network managed by the SMF 200 is the latest information. For example, when the session setting request is received after the freshness period from the time point of collecting the information on the core network, the SMF 200 may determine that the current information on the core network is not the latest information, and may notify the PCF of the occurrence of an error. Conversely, when the period from the time point of collecting the information on the core network to the time point of receiving the session setting request is within the freshness period of the information, the SMF 200 may determine that the current information on the core network is the latest information.

Afterward, the SMF 200 may transmit, to the RSF 100, a path calculation request for transmitting user data in step S225. In an embodiment, the path calculation request may include information on an ingress node and an egress node (for example, internet protocol (IP) addresses and SRv6 addresses of an ingress node and an egress node). In addition, the path calculation request may further include information (single-network slice selection assistance information (S-NSSAI) on a network slice, a DNN, the maximum bit rate (MBR) of an uplink/downlink, and a quality-of-service (QoS) flow identifier (QFT).

In addition, when the path calculation request is transmitted to the RSF 100, information (a service type) on a service provided by a session may be provided to the RSF 100. For example, the path calculation request may include information on a service corresponding to user data to be transmitted.

When the path calculation request is received from the SMF 200, the RSF 100 may determine whether the information on the core network and the information on the transport network have the latest values in step S230. In an embodiment, the RSF 100 may determine whether the information on the core network and the information on the transport network have the latest values, on the basis of a freshness period of the information on the core network transmitted from the SMF 200 and a freshness period of the information on the transport network transmitted from an external AF 300. When the freshness periods of the respective pieces of the information have elapsed from the time points of collecting the information on the core network and the information on the transport network, the RSF 100 may determine that the information on the core network and/or the information on the transport network do not have the latest values. When the information on the core network and/or the information on the transport network do not have the latest values, the RSF 100 may transmit an error response to the SMF 200 in step S235. Herein, the RSF 100 may perform updating on the core network and/or the transport network, and may transmit the error response to be transmitted to the SMF 200 and the time required for updating together.

However, when the information on the core network and/or the information on the transport network have the latest values, the RSF 100 may calculate an optimal path for satisfying the path calculation request on the basis of the information on the integrated network in step S240. In an embodiment, the RSF 100 may consider information on a service (or a service type) included in the path calculation request when calculating an optimal path.

Referring to FIG. 4, the RSF 100 may transmit the calculated optimal path to the SMF 200 in step S245. The SMF 200 may create, on the basis of the optimal path received from the RSF 100 and a PCC rule received from the PCF, policy rules, such as a packet detection rule (PDR), a forwarding action rule (FAR), a QoS enhancement rule (QER), and an SRv6 action rule (SAR), in step S250.

Afterward, the SMF 200 may provide the created policy rules (PDR, FAR, QER, and SAR) to the network resources (an access network and an UPF) of the user plane layer to create a session in steps S255 and S260, and may respond to the PCF with a result of setting the session in step S265.

As described above, the RSF according to an embodiment determines an optimal transmission path of user data on the basis of information on the integrated network, which is determined to be up-to-date or not, thereby satisfying various requirements of application services and improving the quality of the application services.

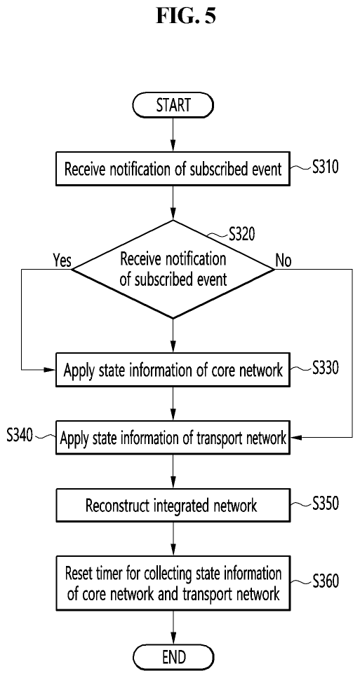

FIG. 5 is a flowchart illustrating a method of creating information on an integrated network according to an embodiment.

An RSF 100 may subscribe to event notification for an SMF 200 to monitor change in state information of an integrated network managed by the SMF 200. In addition, the RSF 100 may subscribe to event notification for an external AF 300 to monitor change in state information of a transport network managed by the external AF.

Referring to FIG. 5, when receiving a notification about the subscribed event from the SMF 200 and/or the external AF 300 in step S310, the RSF 100 may determine the source of the received notification in step S320.

When the received notification is an event notification from the SMF 200, the RSF 100 may cause state information of a core network to influence a core network management function 110 in step S330. When the received notification is an event notification from the external AF 300, the RSF 100 may cause state information of the transport network to influence a transport network management function 120 in step S340.

The RSF 100 may cause the updated state information of the core network and/or transport network to influence information on the integrated network to reconstruct the integrated network in step S350. In addition, the RSF 100 may reset a timer for collecting state information of the core network and/or transport network in step S360.

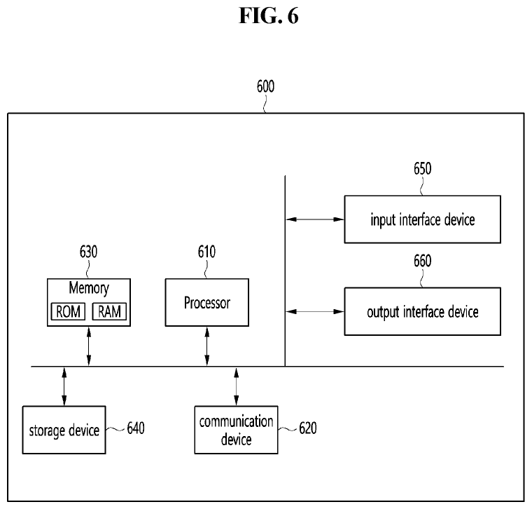

FIG. 6 is a block diagram illustrating a network function in a core network according to an embodiment.

A network function according to an embodiment may be implemented in a computer system, for example, a computer-readable medium. Referring to FIG. 6, a computer system 600 may include at least one of the following: a processor 610, a memory 630, an input interface device 650, an output interface device 660, and a storage device 640 that communicate via a bus 670. The computer system 600 may further include a communication device 620 coupled to a network. The processor 610 may be a central processing unit (CPU) or a semiconductor device that executes commands stored in the memory 630 or the storage device 640. The memory 630 and the storage device 640 may include various types of volatile or non-volatile storage media.

For example, the memory may include a read-only memory (ROM) and a random-access memory (RAM). In an embodiment of the present disclosure, the memory may be located inside or outside the processor and the memory may be connected to the processor through various means known in the art. The memory may be various types of volatile or non-volatile storage media, and for example, the memory may include a read-only memory (ROM) or a random-access memory (RAM).

Accordingly, an embodiment of the present disclosure may be implemented as a method implemented in a computer or as a non-transitory computer-readable medium in which computer-executable commands are stored. In an embodiment, when executed by the processor, the computer-readable commands may perform a method according to at least one aspect of the present disclosure.

The communication device 620 may transmit and receive wired signals or wireless signals.

In the meantime, an embodiment of the present disclosure is not implemented only through an apparatus and/or a method described so far, and may be implemented through a program that realizes a function corresponding to a configuration of the embodiment of the present disclosure, or through a recording medium on which the program is recorded. This implementation can be easily derived by those skill in the art to which the present disclosure pertains from the description of the embodiment above. Specifically, a method (for example, a network management method, a data transmission method, and a transmission schedule generation method) according to an embodiment of the present disclosure may be implemented in the form of program commands executable through various computer means, and may be recorded on a computer-readable medium. The computer-readable recording medium may include program commands, data files, data structures, and the like separately or in combinations. The program commands recorded on the computer-readable medium may be particularly designed and configured for an embodiment of the present disclosure, or may be known to those skilled in the art of computer software and available. The computer-readable recording medium may include hardware devices configured to store and execute program commands. Examples of the computer-readable recording medium include magnetic media such as hard disks, floppy disks, and magnetic tapes; optical recording media such as CD-ROMs, and DVD-ROMs;

magneto-optical media such as floptical disks; ROMs, RAMs, and flash memory. The program commands may include not only machine language codes, which are created by a compiler, but also high-level language codes, which may be executed by a computer by using an interpreter.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A network function in a core network, the network function comprising:
a processor and a memory, wherein the processor is configured to execute at least one program stored in the memory to perform:
receiving, from a session management function (SMF), a path calculation request for a path for transmitting user data, and
determining the path on the basis of information on the core network and information on a transport network coupled to a user plane layer of the core network.

2. The network function of claim 1, wherein the processor is configured to execute the at least one program to further perform:
receiving the information on the transport network from an external application function (AF) outside the core network,
wherein the information on the transport network includes topology of the transport network and state information of network equipment in the transport network.

3. The network function of claim 2, wherein the network equipment in the transport network supports a predetermined transmission protocol.

4. The network function of claim 3, wherein the predetermined transmission protocol is segment routing IPv6 (SRv6).

5. The network function of claim 2, wherein the processor is configured to execute the at least one program to further perform:
receiving the information on the core network from the SMF, and
creating information on an integrated network on the basis of the information on the transport network and the information on the core network,
wherein the information on the integrated network includes integrated topology of the core network and the transport network.

6. The network function of claim 5, wherein when determining the path on the basis of the information on the core network and the information on the transport network coupled to the user plane layer of the core network, the processor is configured to perform:
determining the path on the basis of state information of a network resource in the core network, the state information of the network equipment in the transport network, and topology of the integrated network.

7. The network function of claim 1, wherein the path calculation request includes information on an ingress node and an egress node of the user data, and the ingress node and the egress node are included in the user plane layer.

8. The network function of claim 7, wherein the information on the ingress node and the egress node includes a segment routing IPv6 (SRv6) address of the ingress node and an SRv6 address of the egress node.

9. The network function of claim 7, wherein the path calculation request further includes information on a service corresponding to the user data.

10. A network function in a core network, the network function comprising:
a processor and a memory, wherein the processor is configured to execute at least one program stored in the memory to perform:
receiving a session setting request for a session from a policy control function (PCF),
determining an ingress node and an egress node of user data to be transmitted through the session, and
transmitting a path setting request including information on the ingress node and the egress node to a routing support function (RSF).

11. A path determination method of a core network and a transport network, the path determination method comprising:
receiving, from a session management function (SMF), a path calculation request for a path for transmitting user data; and
determining the path on the basis of information on the core network and information on the transport network coupled to a user plane layer of the core network.

12. The path determination method of claim 11, further comprising:
receiving the information on the transport network from an external application function (AF) outside the core network,
wherein the information on the transport network includes topology of the transport network and state information of network equipment in the transport network.

13. The path determination method of claim 12, wherein the network equipment in the transport network supports a predetermined transmission protocol.

14. The path determination method of claim 13, wherein the predetermined transmission protocol is segment routing IPv6 (SRv6).

15. The path determination method of claim 12, further comprising:
receiving the information on the core network from the SMF; and
creating information on an integrated network on the basis of the information on the transport network and the information on the core network,
wherein the information on the integrated network includes integrated topology of the core network and the transport network.

16. The path determination method of claim 15, wherein the determining of the path on the basis of the information on the core network and the information on the transport network coupled to the user plane layer of the core network comprises:
determining the path on the basis of state information of a network resource in the core network, the state information of the network equipment in the transport network, and topology of the integrated network.

17. The path determination method of claim 11, wherein the path calculation request includes information on an ingress node and an egress node of the user data, and the ingress node and the egress node are included in the user plane layer.

18. The path determination method of claim 17, wherein the information on the ingress node and the egress node includes a segment routing IPv6 (SRv6) address of the ingress node and an SRv6 address of the egress node.

19. The path determination method of claim 17, wherein the path calculation request further includes information on a service corresponding to the user data.
